(19) United States
(12) Patent Application Publication
(10) Pub. No.: US 2007/0296927 A1
(43) Pub. Date: Dec. 27, 2007

(54) Projector lamp module

(75) Inventors: Yao-Min Chang, Taipei City (TW); Sheng-Chang Lu, Magong City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/806,029

(22) Filed: May 29, 2007

(30) Foreign Application Priority Data
Jun. 21, 2006 (TW) 095122308

(51) Int. Cl. G03B 21/16

(52) U.S. Cl. 353/52

(57) ABSTRACT

A projector lamp module for use with a cooler is provided. The lamp module comprises a light device, a housing and at least one cover. The housing is disposed on one end of the light device. An airflow entrance is formed on the housing. The cover plate is movably disposed on the housing and covers the airflow entrance. When the lamp module and the cooler are assembled together, the cover plate is removed and uncovered the entrance draft.

This application claims priority based on a Taiwanese patent application No. 095122308 filed on Jun. 21, 2006.

### BACKGROUND OF THE INVENTION

1. Field of the Invention

The present invention relates generally to a lamp module and more particularly to a projector lamp module having a movable cover.

2. Description of the Prior Art

Along with the well-developed projector market, the volume of a projector is gradually minimized from the size bigger than a notebook to the size of a B5 paper. In the beginning, the heat dissipation technique is not difficult because the size of the projector is bigger. However, as the market demand toward small sized projectors increases, the heat dissipation technique and the mechanical design become more and more complicated.

It is easy to see that small size/light weight, high illumination and low noises are the development trends of the future projectors. However, these trends encounter the same problem, which is the heat dissipation. With a smaller volume but having the same elements, the total heat dissipation of a projector is the same but the heat dissipation per unit area will increase. If the heat dissipation per unit area cannot be increased, we can only lower or control the total heat in the projector. The main heat source in a projector is the lamps. The only way to lower the total heat of the lamps is decreasing the illumination of the lamp, but unfortunately this will be against the trend of high illumination.

Therefore, the heat dissipation problem of the system is usually solved by controlling the heat dissipation of the lamps. As shown in FIG. 1, traditional projectors are usually equipped with powerful fans 10, which can be used for directly controlling the heat dissipation by generating wind at a higher speed from the meshed cover 16 to the lamp module 12. Wherein, the meshed cover 16 is fixed at a fine tuned angle on one side of the housing 14 of the lamp module 12 for wind blowing to the main heat source—the lampwick. A fixed meshed cover 16 is provided to prevent broken pieces of the light bulb 18 of an exploded lamp from falling off while replacing the broken light bulb 18 with a new one.

However, a conventional meshed cover 16 often changes the wind direction and affects the wind velocity. Therefore, the conventional mesh often increases the loading of the fan 10 (increases the rotational speed of the fan 10) and has no contribution to heat dissipation and the cooling-down problem for the conventional projector and particularly for the light bulb 18. In order to catch up with the developing trend of the future projectors, the techniques of the heat dissipation and the design of mechanism should be considered more completely and carefully.

### SUMMARY OF THE INVENTION

It is an object of the present invention to provide a projector lamp module to both satisfy the security and enhance the cooling effect.

It is an object of the present invention to provide a positive, effective and able to control the cooling direction and area of the projector lamp module.

It is a main objective of the invention to provide a projector lamp module, which can satisfy the safety demand and enhance the cool effect. It is a main objective of the invention to provide an active, effective lamp module of a projector for controlling the cooling direction and area.

A lamp module of a projector for use with a cooler, comprising a light device, a housing and at least one cover. The housing is disposed on one end of the light device. An airflow entrance is formed on the side of the housing. The cover is movably disposed on the housing and covers the airflow entrance. When the lamp module and the cooler are assembled together, the cover is movable relative to the airflow entrance and exposing the airflow entrance.

In a preferred embodiment, the housing includes at least one track disposed on one side of the airflow entrance, and the cover is movably connecting with said track. The cover is preferably a meshed cover. One side of the meshed cover is formed with a blocking unit and connecting at least one elastic member. When assembling said lamp module and said cooler together, said cooler pushes said block unit to move said meshed-cover away from the airflow entrance along the track and the wind blows the light device without any block.

In another preferred embodiment, a steering device is disposed on one side of the airflow entrance and assembled with the protruding element of the upper cover of the projector. An elastic member connects with a steering device for returning the steering device to the initial position. The cover is preferably an airtight baffle which can be opened with an angle to connect with the sides of the housing. When assembling the lamp module to the assembly holes of the projector, the protruding element drives the gear device to open the cover with an angle and thereby guide the airflow into the light device.

### BRIEF DESCRIPTION OF THE DRAWINGS

FIG. 1 shows a view of the prior art while a blower and a light source are assembled together;

FIG. 2 shows a sectional three-dimensional front view of the projector according to the present invention;

FIG. 3 shows a sectional three-dimensional bottom view diagram of the projector according to present invention;

FIG. 4 shows a three-dimensional view while taking out the lamp module from the projector of the present invention;

FIG. 5 is a view of the prefer embodiment of the present invention;

FIG. 6 is a three-dimensional view while assemble with the cooler shown in FIG. 5;

FIG. 7 shows a view of another embodiment of the lamp module according to the present invention;

FIG. 8 is a motion diagram for the embodiment shown in FIG. 7.

FIG. 9 illustrates a three-dimensional diagram of a further embodiment according to the present invention; and

FIG. 10 is a motion diagram for the embodiment shown in FIG. 9;

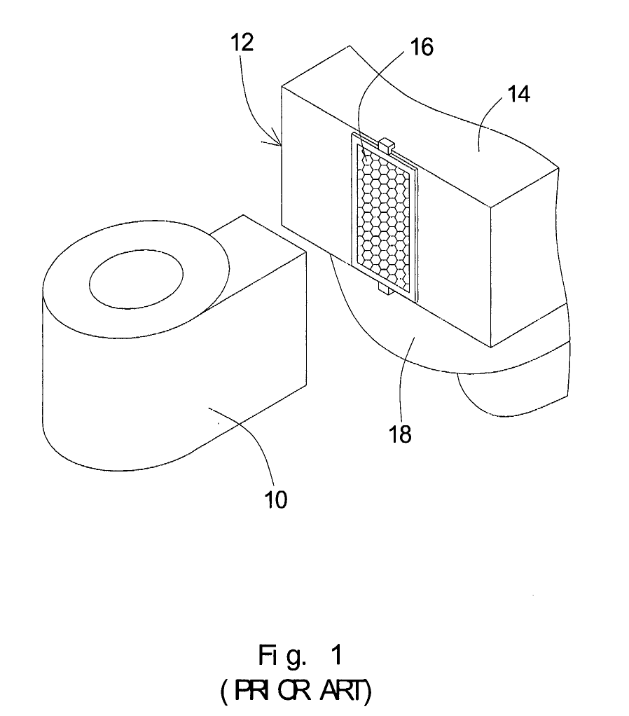

### DETAILED DESCRIPTION OF THE PREFERRED EMBODIMENT

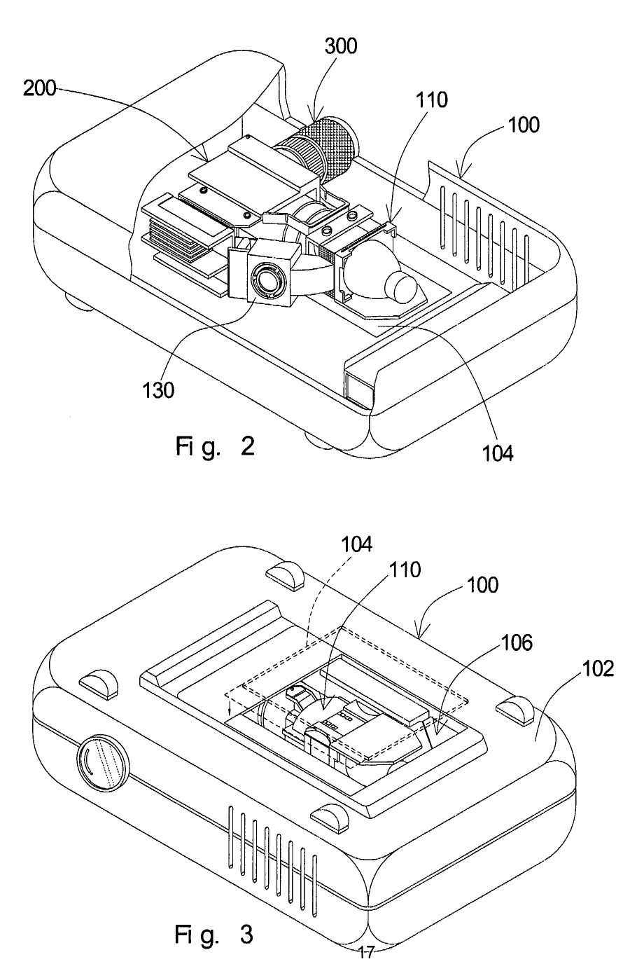

As FIG. 2 shows, the projector 100 of the present invention mainly comprises a lamp module 110, an optical engine unit 200, a projecting camera lens unit 300 and a circuit system unit (not illustrated). In the present invention we will mainly describe the cooling method of the lamp module 110. In a preferred embodiment, the lamp module 110 preferably uses an ultra high performance lamp (UHP). However, in a different embodiment, the lamp module 110 can use a pure xenon lamp or the other high power lamps. The preferred embodiments of the present invention are illustrated hereunder with attached drawings.

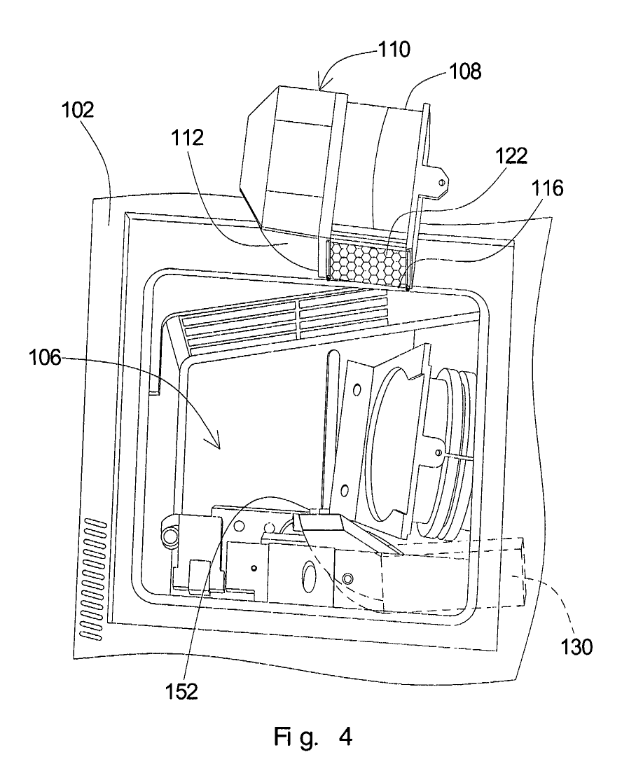

The lamp module 110 is a kind of an expendable product. In addition to that, the usage time, the environment, the users' operation and other reasons may also cause pre-exhaustion or explosion of the lamps. Therefore, in the bottom 102 of the projector 100 generally is disposed a bottom cover 104 for replacing the lamp module 110, as shown in FIG. 3. FIG. 4 is an embodiment which shows the lamp module 110 removed from the assembly hole 106 of the bottom 102. The lamp module 110 of this embodiment is mainly used with a cooler 130.

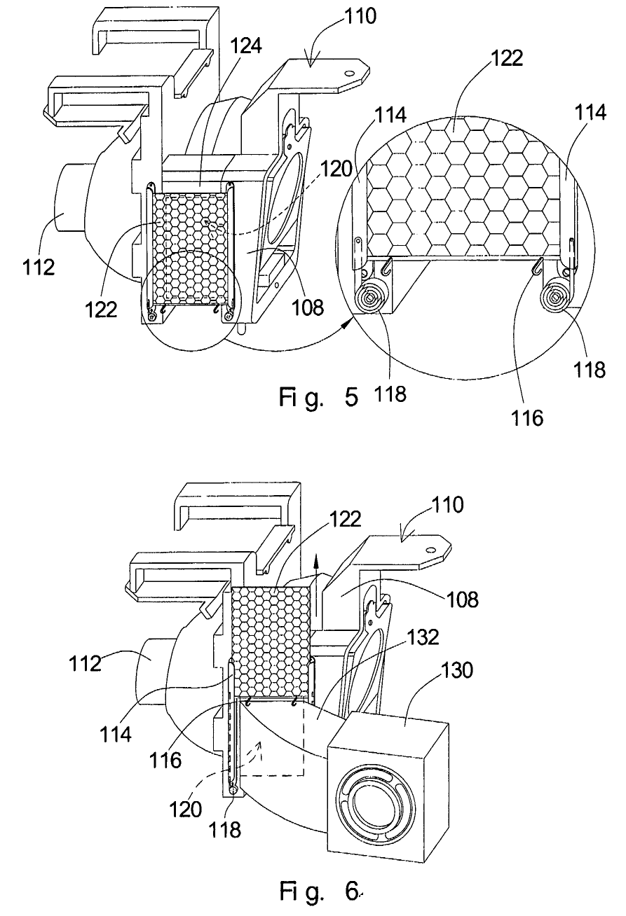

As FIG. 5 shows, the lamp module 110 includes a light device 112, a housing 108 and at least one cover 122. In a preferred embodiment, the light device 112 is an ultra high performance lamp which has been mentioned above. The housing 108 is disposed on one end of the light device 112, and an airflow entrance 120 is disposed on a side wall 124 of the housing 108. The cover 122 is movably disposed on the housing 108 and covering or exposing the airflow entrance 120. When assembling the lamp module 110 and the cooler 130, the cover 122 is removed and exposed the airflow entrance 120. In addition to that, the airflow entrance 120 is provided as an entrance and an exit for the air that is needed for thermal dissipation. Because the light device 112 will probably explode when it is in use, in order to prevent the fragments from being scattered to other locations of the projector 100 and to prevent the end users from injury when replacing the lamp module 110, the cover 122 is needed to be disposed corresponding to the airflow entrance 120.

In the preferred embodiment as shown in FIG. 5, the cover 122 is a meshed cover. In addition, the embodiment preferably has two tracks 114 disposed on the two sides of the airflow entrance 120, and movably engaged with the cover 122. At least one block unit 116 is disposed on one side of the cover 122 for the external force to input force on it. The block unit 116 is preferably a hook, but it can also be a protruding element or any kind of object that can push the cover 122. In the other embodiment, the cover 122 is pushed by the protruding element (not illustrated) disposed on the air draft pipe 132 of the cooler 130. The cover 122 connects with at least one elastic member 118 for driving the cover 122 back to the initial position by the elasticity of the elastic member 118. The elastic member 118 is preferably a coiled spring, a volute spring or the other constant force spring and is fixed on the two side edge of the cover 122.

As shown in FIG. 6, when replacing the light device 112 of the lamp module 110 and assembling it back to the projector 100, the light device 112 will move a relative motion to the cooler 130. When the lamp module 110 and the cooler 130 are assembled together, the cooler 130 is immovably fixed. Therefore, the air draft pipe 132 of the cooler 130 will push the block unit 116 of the cover 122 and the cover 122 will move along the track 114 away from the airflow entrance 120, and expose the airflow entrance 120. When the assembly is completed, the airflow of the cooler 130 will blow into the light device 112 directly without obstruction.

When the light device 112 of the lamp module 110 explodes, exhausts or occurs other problems, the lamp module 110 must be replaced. When taking out the lamp module 110, because the pulling force of the elastic member 118 gradually disappears, the elastic member 118 will pull back the cover 122 until the airflow entrance 120 is covered or exposed completely. Therefore, the cover 122 can prevent the fragments due to the lamp explosion from being scattered from the airflow entrance 120 to the lamp module 110.

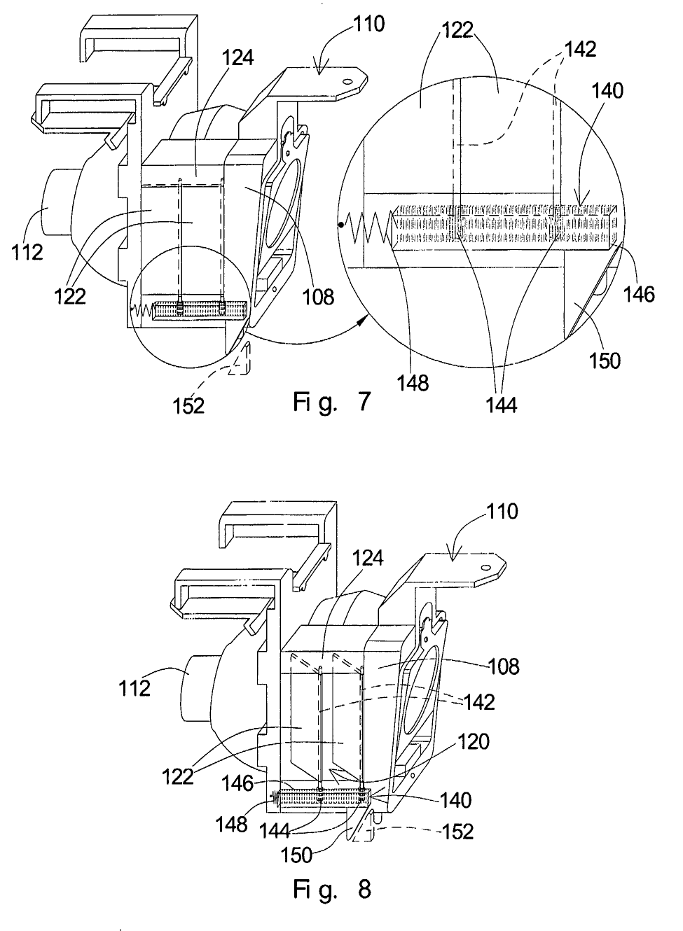

FIG. 7 shows another preferred embodiment of the present invention. A steering device 140 is mainly disposed on one side of the airflow entrance 120, and a shaft 142 across the cover 122 is disposed on one side of the cover 122. The shaft 142 connects the cover 122 to the housing 108 and enables the cover 122 to rotate relative to the airflow entrance 120. In the preferred embodiment shown in FIG. 7, the cover 122 is preferably composed of two airtight baffles that can be opened to an angle by controlling the steering device 140.

In the embodiment, the steering device 140 preferably includes a gear wheel 144 and a rack 146. The gear wheel 144 is disposed on one end of the shaft 142, and the rack 146 is disposed under the cover 122 and engages with the gear wheel 144. An elastic member 148 connects to one side of the rack 146, and a guiding portion 150 is disposed on the other side of the rack 146. The elastic member 148 is preferably a coiled spring, a volute spring or other similar spring. The guiding portion 150 is preferably a triangle for use with the protruding element 152. The protruding element 152 is preferably disposed on the upper cover (not illustrated) of the projector. However, in a different embodiment, the protruding element 152 can be disposed in other place.

As shown in FIG. 8, when assembling the lamp module 110, the protruding element 152 pushes the guiding portion 150 by taking the advantage of the incline. The rack 146 moves sidelong to drive the gear wheel 144 to rotate and the cover 122 to open to an angle. The angle is preferably adjustable for controlling the wind direction and the wind receiving area. When the shortest side of the triangle of the protruding element 152 becomes longer, the rack 146 will move a longer distance sidelong, and the cover 122 will be opened to a bigger angle and vice versa. When lamp module 110 escaped from the protruding element 152, the elastic member 148 which connects to the other side of the steering device 140 regain the elasticity. The rack 146 and the gear wheel 144 returns to the initial position, and the cover 122 is taken out while it is covering or exposing the airflow entrance 120.

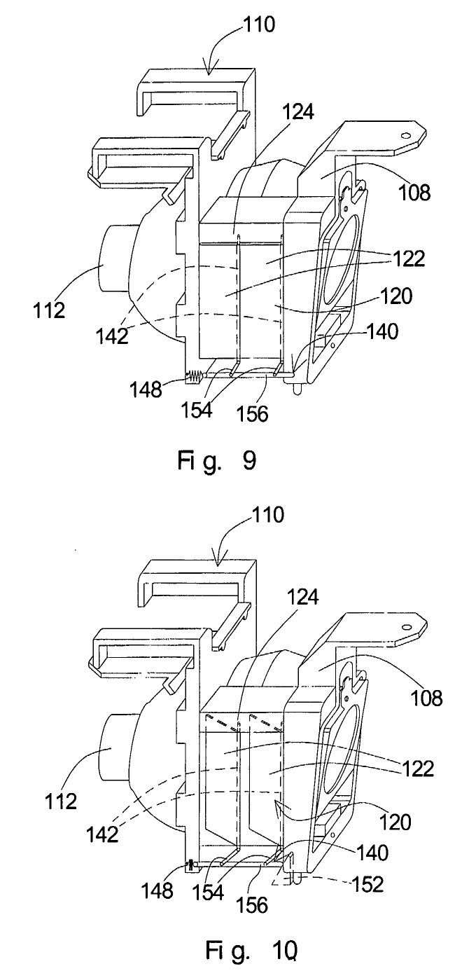

FIG. 9 shows another embodiment of the present invention. The embodiment shows another steering device 140 to drive the cover 122 to open to an angle. In the embodiment, the steering device 140 comprises a connecting rod 154, a crank 156 and an elastic member 148. The connecting rod 154 connects to one end of the shaft 142, and the crank 156 connects to one end of the connecting rod 154. When the steering device 140 is in the initial position, the cover 122 is covering the airflow entrance 120 of the lamp module 110. As the embodiment shown in FIG. 9, the cover 122 preferably has two baffles, and the two baffles are separately connect to the two shafts 142. The connecting rod 154 preferably connects to the ends of the two shafts 142 separately.

As shown in FIG. 10, when assembling the lamp module 110, the incline of the protruding element 152 drives or pushes the crank 156 of the steering device 140. The crank 156 drives the connecting rod 154 to rotate and the cover 122 to open to an angle at the same time. In addition, the elastic member 148 is in a compressed status, too. As the embodiment shows in FIG. 10, the open angle is preferably controlled by the shortest side of the triangle of the protruding element 152. In the other words, when the shortest side of the triangle of the protruding element 152 is longer, the crank 156 will move a longer distance sidelong and the cover 122 will opened to a bigger angle.

When the steering device 140 escapes from the protruding element 152, the elastic member 148 regains the elasticity and drives or pushes the crank 156 back to the initial position. The connecting rod 154 drives the shaft 142, enabling the cover 122 to return back to the initial position and exposes or covers the airflow entrance 120.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claim:

1. A projector lamp module for use with a cooler, comprising:
a light device;
a housing disposed on one end of said light device and having an airflow entrance; and
at least one cover movably disposed on said housing and covered up said airflow entrance;
wherein, said cover is movable relative to said airflow entrance and exposing said airflow entrance.

2. The projector lamp module of claim 1, wherein said housing includes at least one track disposed on one side of said airflow entrance, and said cover is movably and connects with said track.

3. The projector lamp module of claim 1, wherein said cover includes a meshed-cover.

4. The projector lamp module of claim 3, wherein one side of said meshed-cover includes at least one block unit.

5. The projector lamp module of claim 1, wherein said cover includes a shaft across said cover, and said shaft connects said cover to said housing and enables said cover to rotate relative to said airflow entrance.

6. The projector lamp module of claim 5, wherein said cover includes at least one baffle.

7. The projector lamp module of claim 6, further comprising a steering device disposed on one side of said baffle, and one side of said steering device has a guiding portion.

8. The projector lamp module of claim 7, wherein said steering device further includes an elastic member, said elastic member is connected with said steering device to regain said baffle back to an initial position.

9. The projector lamp module of claim 7, wherein said steering device includes a rack, one end of said shaft includes a gear wheel engaging said rack, when said guiding portion is moved, said gear wheel drives said baffle to open said angle.

10. The projector lamp module of claim 7, wherein said steering device includes a crank, one end of said shaft includes a connecting rod, said connecting rod connects said crank, when said crank is moved, said connecting rod moves with said baffle and drives said baffle to open said angle.

11. A projector lamp module for use with a cooler, comprising:
a light device;
a housing disposed on the one end of said light device and having an airflow entrance and at least one track, said track disposed on one side of said airflow entrance; and
a meshed-cover disposed corresponding to said airflow entrance, said meshed-cover comprising a block unit, said meshed-cover covering said airflow entrance and movably connecting to said track;
wherein, said cooler driving said block unit, said meshed-cover is movable relative to said airflow entrance and exposing said airflow entrance.

12. The projector lamp module of claim 11, wherein said block unit includes a column.

13. The projector lamp module of claim 11, wherein said block unit includes a hoot.

14. The projector lamp module of claim 11, wherein said housing further includes an elastic member, said elastic member is connected with said meshed-cover to regain said meshed-cover back to an initial position.

15. A projector lamp module for use with a cooler, comprising:
a light device;
a housing disposed on the one end of said light device and having an airflow entrance and at least one baffle, said baffle covering said airflow entrance and movably connecting to said airflow entrance; and
a steering device disposed on one side of said baffle;
wherein, when said baffle is moved, said steering device drives relative movement.

16. The projector lamp module of claim 15, wherein said housing further includes an elastic member, said elastic member connects with said steering device to regain said baffle back to an initial position.

17. The projector lamp module of claim 15, wherein said baffle includes a shaft across said cover, said shaft connects to said housing and enables said cover rotates relative to said airflow entrance.

18. The projector lamp module of claim 15, wherein one side of said steering device includes a guiding portion.

19. The projector lamp module of claim 15, wherein said steering device including a rack, one end of said shaft including a gear wheel engaging said rack, when said guiding portion is moved, said gear wheel drives said baffle to open said angle.

20. The projector lamp module of claim 15, wherein said steering device includes a crank, one end of said shaft includes a connecting rod, said connecting rod connects said crank, when said crank is moved, said connecting rod move with said baffle and drives said baffle to open said angle.
